(19) United States
(12) Patent Application Publication
(10) Pub. No.: US 2015/0200033 A1
(43) Pub. Date: Jul. 16, 2015

(54) COPPER ALLOY FOR ELECTRIC AND ELECTRONIC PARTS

(71) Applicant: Kabushiki Kaisha Kobe Seiko Sho (Kobe Steel, Ltd.), Kobe-shi (JP)

(72) Inventor: Yuya SUMINO, Shimonoseki-shi (JP)

(73) Assignee: Kabushiki Kaisha Kobe Seiko Sho (Kobe Steel, Ltd.), Kobe-shi (JP)

(21) Appl. No.: 14/560,626

(22) Filed: Dec. 4, 2014

(30) Foreign Application Priority Data
Jan. 15, 2014 (JP) 2014-005470

(51) Int. Cl. H01B 1/02; C22C 9/04; C22C 9/00

(52) U.S. Cl. CPC H01B 1/026; C22C 9/00; C22C 9/04

(57) ABSTRACT

A Cu—Cr—Ti—Si alloy for electric and electronic parts comprises Cr: 0.15-0.4 mass %, Ti: 0.005-0.15 mass %, and Si: 0.01-0.05 mass % with the remainder consisting of Cu and inevitable impurities, in which the contents of S, O, and C out of the inevitable impurities are; S: 0.005 mass % or less, O: 0.005 mass % or less, and C: 0.004 mass % or less, and the total content of S, O, and C is 0.007 mass % or less. According to the necessity, one element or more selected from the group consisting of Zn, Sn, and Mg may be further contained by 0.001-1.0 mass % in total. The Cu—Cr—Ti—Si alloy improves stress relaxation resistance characteristic in electric and electronic parts.

### BACKGROUND OF THE INVENTION

1. Field of the Invention

The present invention relates to a copper alloy for electric and electronic parts, specifically to a Cu—Cr—Ti—Si alloy for electric and electronic parts, having high strength and high electric conductivity excellent in stress relaxation resistance characteristic and heat peeling resistance of Sn coating.

2. Description of the Related Art

As a copper alloy used for a terminal of electrical equipment mounted on an automobile, a Cu—Ni—Si alloy having excellent balance of characteristics such as electric conductivity, strength, stress relaxation resistance characteristic, bending workability, heat peeling resistance of Sn coating and the like has been commonly used. The electric conductivity of the Cu—Ni—Si alloy is approximately 30-50% IACS normally.

On the other hand, the demand for reduction of the thickness and miniaturization of a terminal has become stronger because of the weight reduction trend of an automobile, and such copper alloy has been required that further improves electric conductivity while maintaining the level of the Cu—Ni—Si alloy in the properties such as the strength, stress relaxation resistance characteristic, bending workability and the like.

With respect to such requirement, a Cu—Cr—Ti—Si alloy has been proposed (refer to JP-A 2012-214882). The Cu—Cr—Ti—Si alloy described in JP-A 2012-214882 contains Cr: 0.10-0.50 mass %, Ti: 0.005-0.50 mass %, and Si: 0.005-0.20 mass % with O being restricted to 150 ppm or less, H being restricted to 5 ppm or less, and the remainder consisting of Cu and inevitable impurities. This copper alloy has the properties of 65% IACS or more of electric conductivity, 460 MPa or more of 0.2% proof stress, 20% or less of stress relaxation ratio after being held for 24 hours at 180° C. (equivalent to being held for 1,000 hours at 150° C.).

### SUMMARY OF THE INVENTION

Although use of the Cu—Cr—Ti—Si alloy described in JP-A 2012-214882 has been started as a material of a fitting type terminal and the like used in a range of the electric conductivity higher than that of the Cu—Ni—Si alloy, in order to secure the contact reliability of a terminal particularly under a high temperature environment such as in an engine room of an automobile and the like, further improvement of the stress relaxation resistance characteristic has been required.

Accordingly, the object of the present invention is to improve the stress relaxation resistance characteristic of the Cu—Cr—Ti—Si alloy.

Although the price of a high purity copper metal manufactured by an electrolytic process from copper ore was 200-300 yen/kg about ten years ago, due to recent increase of the demand of copper, price control caused by mergers of mining companies, and so on, the price of the high purity copper metal has risen to 800-1,000 yen/kg. Also, in order to respond the social requirement of effective use and improvement of the recycling rate of the resources, the mixing ratio of the low purity copper metal, a lead frame and terminal punching scraps generated at clients, cable wire scraps, air conditioner scraps and the like in the market, in addition to the scraps generated in the copper mills having been used in the past, to the melting raw material has risen.

Impurities such as S, O, Pb, Bi and the like are included comparatively much in the low purity copper metal, and rolling oil, press lubricating oil, copper oxide and the like are attached to the scraps. Because the mixing ratio of these low purity copper metal and scraps to the melting raw material has risen, the content of the impurity elements such as S, C, O and the like in the copper alloy tends to rise (S and O are included much in rolling oil and lubricating oil). On the other hand, the Cu—Cr—Ti—Si alloy contains Cr, Ti, and Si that easily form compounds with S, C, and O as main additive elements. S, C, and O brought into the melting raw material bond with Cr, Ti, and Si to form sulfides, carbides, and oxides, and consume Cr, Ti, and Si that are solid-dissolved or precipitated in the copper alloy matrix and enhance the stress relaxation resistance characteristic. In other words, the stress relaxation resistance characteristic of the Cu—Cr—Ti—Si alloy may possibly improve further by reducing S, C, and O which consume Cr, Ti, and Si.

Based on such way of thinking, the present inventor reduced S, C, and O in the Cu—Cr—Ti—Si alloy, and, as a result, could improve the stress relaxation resistance characteristic of the Cu—Cr—Ti—Si alloy.

The copper alloy for electric and electronic parts related with an aspect of the present invention contains Cr: 0.15-0.4 mass %, Ti: 0.005-0.15 mass %, and Si: 0.01-0.05 mass % with S, O, and C being restricted to S: 0.005 mass % or less, O: 0.005 mass % or less, and C: 0.004 mass % or less respectively, the total of S, O, and C being restricted to 0.007 mass % or less, and the remainder consisting of Cu and inevitable impurities. According to the necessity, this copper alloy further contains one element or more selected from the group consisting of Zn, Sn, and Mg by 0.001-1.0 mass % in total.

According to the present invention, by reducing the total contents of S, O, and C in the copper alloy for electric and electronic parts (Cu—Cr—Ti—Si alloy), the stress relaxation resistance characteristic can be improved without deteriorating the properties such as the strength, electric conductivity, bending workability and the like of the alloy. The copper alloy for electric and electronic parts related to the present invention has the properties of 20% or less of the stress relaxation ratio after being held for 1,000 hours at 160° C., and, when it is used for a fitting type terminal and the like for example, the contact reliability of the terminal under a high temperature environment in particular such as in an engine room of an automobile can be secured.

### BRIEF DESCRIPTION OF THE DRAWING

FIG. 1 is a photo of a microscopic structure of a test sample of Example No. 1.

### DETAILED DESCRIPTION OF THE PREFERRED EMBODIMENTS

Below, the copper alloy for electric and electronic parts (Cu—Cr—Ti—Si alloy) related to an aspect of the present invention will be described more specifically.

[Chemical composition of Cu—Cr—Ti—Si alloy]

Cr: 0.15-0.4 mass %

Cr and an intermetal compound such as Cr—Si, Cr—Ti, Cr—Si—Ti improves the strength of the copper alloy by precipitation hardening. By this precipitation, the solid solution amount of Cr, Si, and Ti in the Cu matrix reduces and the electric conductivity of the copper alloy improves. When Cr content is less than 0.15 mass %, increase of the strength by precipitation is insufficient, and the stress relaxation resistance characteristic do not improve. On the other hand, when Cr content exceeds 0.4 mass %, it becomes a cause of coarsening of the precipitates, and the stress relaxation resistance characteristic and bending workability deteriorate. Therefore, Cr content is made in the range of 0.15-0.4 mass %, the lower limit is made preferably 0.25 mass %, more preferably 0.27 mass %, and the upper limit is made preferably 0.35 mass %, more preferably 0.30 mass %.

Ti: 0.005-0.15 mass %

Ti as solid-dissolved in the Cu matrix improves the heat resistance property and the stress relaxation resistance characteristic of the copper alloy. Also, Ti forms precipitates with Cr and Si, and improves the strength of the copper alloy by precipitation hardening. By this precipitation, the solid solution amount of Cr, Si, and Ti in the Cu matrix reduces and the electric conductivity of the copper alloy improves. When Ti content is less than 0.005 mass %, the heat resistance property of the copper alloy is low, the copper alloy is softened in the annealing step, and high strength is hardly secured. Also, the stress relaxation resistance characteristic of the copper alloy cannot be improved. On the other hand, when Ti content exceeds 0.150 mass %, the solid solution amount of Ti in the Cu matrix increases, and the electric conductivity deteriorates. Therefore, Ti content is made in the range of 0.005-0.150 mass %, the lower limit is made preferably 0.030 mass %, more preferably 0.050 mass %, and the upper limit is made preferably 0.130 mass %, more preferably 0.100 mass %.

Si: 0.01-0.05 mass %

Si forms Cr—Si and Cr—Si—Ti compounds with Cr and Ti, and increases the strength of the copper alloy by precipitation hardening. By this precipitation, the solid solution amount of Cr, Si, and Ti in the Cu matrix reduces and the electric conductivity improves. When Si content is less than 0.01 mass %, improvement of the strength by Cr—Si precipitates or Cr—Si—Ti precipitates is insufficient. On the other hand, when Si content exceeds 0.05 mass %, the solid solution amount of Si in the Cu matrix increases, and the electric conductivity deteriorates. Also, Cr—Si precipitates are coarsened, and the bending workability and the stress relaxation resistance characteristic deteriorate. Therefore, Si content is made in the range of 0.01-0.05 mass %, the lower limit is made preferably 0.015 mass %, more preferably 0.02 mass %, and the upper limit is made preferably 0.03 mass %, more preferably 0.025 mass %.

S: 0.005 mass % or less

O: 0.005 mass % or less

C: 0.004 mass % or less

Total of S, O, and C (S+O+C): 0.007 mass % or less

Among the inevitable impurities, each of S, O, and C forms compounds as follows (sulfides, oxides, carbides, and composite compound thereof) with Cr, Ti, and Si that are indispensable elements of the copper alloy (Cu—Cr—Ti—Si alloy) related to an aspect of the present invention, and exists in the Cu matrix as inclusions having the diameter of submicron or approximately 10 μm. These inclusions do not contribute to improvement of the strength and the stress relaxation resistance characteristic, Cr, Ti, and Si are consumed by formation of these inclusions, and therefore the precipitation amount of intermetallic compounds including Cr, Ti, and Si and the amount of Ti solid-dissolved into the Cu matrix reduce.

Sulfides: Ti—S(TiS, TiS₂, TiS₃ and the like), Cr—S(Cr₂S₃ and the like), Si—S (SiS₂ and the like), and composite sulfides including two elements or more selected from the group consisting of Ti, Cr, and Si.

Oxides: Ti—O (TiO, TiO₂, Ti₂O₃ and the like), Cr—O (Cr₂O₃, CrO₂, CrO₃ and the like), Si—O (SiO₂ and the like), and composite oxides including two elements or more selected from the group consisting of Ti, Cr, and Si.

Carbides: Ti—C(TiC and the like), Cr—C(Cr₂₃C₆, Cr₇C₃, Cr₃C₂ and the like), Si—C(SiC and the like), and composite carbides including two elements or more selected from the group consisting of Ti, Cr, and Si.

Composite compounds: Ti—C—S—O, Cr—Ti—S—O, Cr—Ti—Si—S—O, Cr—C—O, Si—S—O and the like.

In order to suppress consumption of Cr, Ti, and Si by S, O, and C and to exert excellent stress relaxation resistance characteristic which the copper alloy related to an aspect of the present invention essentially has, S content should be 0.005 mass % or less, O content should be 0.005 mass % or less, C content should be 0.004 mass % or less, and the total content of S, O, and C should be 0.007 mass % or less. Both of the S content and O content are made preferably 0.003 mass % or less, more preferably 0.001% or less, and C content is made preferably 0.002 mass % or less, more preferably 0.001% or less. Also, the total content of S, O, and C is made preferably 0.005 mass % or less, more preferably 0.003% or less.

Zn: 0.001-1.0 mass %

Sn: 0.001-1.0 mass

Mg: 0.001-0.05 mass %

Total of Zn, Sn, and Mg (Zn+Sn+Mg): 1.0 mass % or less

Zn is an element effective in improving the heat peeling resistance of Sn coating or solder used for bonding of electronic parts. Sn and Mg enhance the work hardening property by cold rolling, and are effective in increasing the strength of the copper alloy and in improving the stress relaxation resistance characteristic. However, when all of Zn, Sn, and Mg contents are less than 0.001 mass %, the effect thereof is less, whereas when Zn and Sn content exceeds 1.0 mass % or Mg content exceeds 0.05 mass %, the electric conductivity of the copper alloy deteriorates. Also, when the total of Zn, Sn, and Mg contents exceeds 1.0 mass %, the electric conductivity of the copper alloy deteriorates. Therefore, with respect to the copper alloy related to an aspect of the present invention, Zn and Sn are to be added in the range of 0.001-1.0 mass % and Mg is to be added in the range of 0.001-0.05 mass % by single or by combination of two elements or more according to the necessity, and the total content thereof is made 1.0 mass % or less.

The lower limit of Zn content is preferably 0.01 mass %, more preferably 0.1 mass %, and the upper limit is preferably 0.8 mass %, more preferably 0.6 mass %. The lower limit of Sn content is preferably 0.01 mass %, more preferably 0.1 mass %, and the upper limit is preferably 0.8 mass %, more preferably 0.6 mass %. The lower limit of Mg content is preferably 0.005 mass %, more preferably 0.01 mass %, and the upper limit is preferably 0.04 mass %, more preferably 0.035 mass %. The upper limit value of the total of the Zn, Sn, and Mg contents is preferably 0.8 mass %, more preferably 0.6 mass %.

Inevitable Impurities

The copper alloy (Cu—Cr—Ti—Si alloy) related to an aspect of the present invention possibly contains one element or more selected from the group consisting of Al, Fe, Ni, As, Sb, B, Pb, V, Zr, Mo, Mn, Hf, Ta, Bi, Ag, In, and Co as the inevitable impurities. In the Cu—Cr—Ti—Si alloy, Al, Fe, Ni, As, Sb, B, Pb, V, Zr, Mo, Mn, Hf, Ta, Bi, Ag, In, and Co are normally within the range of 0.1 mass % or less in total unless they are not added in particular (namely, as the inevitable impurities), and no problem occurs with respect to the properties when the total content is within the range. Also, when the total content of these elements exceeds 0.1 mass %, there comes up the possibility that the stress relaxation resistance characteristic and the bending workability deteriorate and the electric conductivity drops.

Among the inevitable impurities, H makes gas bubbles (hereinafter referred to as “blow hole”) in the ingot, and deteriorates the quality of the ingot. Also, the blow hole causes the internal crack in hot rolling and deteriorates the hot workability. Therefore, H content is made in the range of 0.0002 mass % or less. H content is preferably 0.00015 mass % or less, more preferably 0.0001 mass % or less.

### [Manufacturing Method]

### (Melting and Casting Step)

The content of S, O, and C in the copper alloy is determined in the melting and casting step. In order to suppress S, O, and C contents in the copper alloy, melting and casting are executed with the following procedure for example.

(1) Copper metal and various kinds of scraps are blended and are charged to a melting furnace, charcoal and graphite grains are scattered, and molten metal of approximately 1,150-1,250° C. is smelted while Ar gas, nitrogen gas and the like having a low dew point are made to flow inside the furnace.
(2) The molten metal is sampled, and the content of S, O, and C is measured.
(3) In order to reduce S content in the molten metal, Ca and Mg that more easily form sulfides than Ti, Cr, and Si do (Ca and Mg are positioned lower than Ti, Cr, and Si in the standard free energy of formation-temperature diagram for sulfides) are added to the molten metal by a minute amount, and preliminary desulfurization is executed. After the preliminary desulfurization, the molten metal is sampled, and S content is confirmed.
(4) In order to reduce C content in the molten metal, Zr, Al and the like that more easily form carbides than Ti, Cr, Si do are added to the molten metal by a minute amount, and preliminary decarburization is executed. In order to prevent C from intruding into the molten metal after the preliminary decarburization, the size of the charcoal and graphite grains covering the molten metal surface is made large to reduce the contact area with the molten metal. Also, the scattering amount of the charcoal and graphite grains is reduced, the flow rate of Ar gas and nitrogen gas is increased to enhance the sealing effect in the furnace.
(5) By taking the actions of (3) and (4) described above, O content can be also reduced. However, when O content of the molten metal drops to less than 0.0003 mass %, H easily intrudes into the molten metal from the atmosphere, and therefore O content is made not to become less than 0.0003 mass %. Because H is brought into the molten metal also from the atmosphere inside the furnace and the water attached to the raw material, attention should be paid to use Ar gas and nitrogen gas having low dew point, to dry the raw material charged, to use red-hot charcoal and graphite grains, and so on.

Also, because all of sulfides, carbides, and oxides have smaller density than that of the molten metal of Cu, when the molten metal is left to stand still, they easily float to the molten metal surface as the slag. It is preferable to remove the slag that has floated to the molten metal surface.

(6) After preparation of the molten metal by the procedure described above, the alloy elements such as Cr, Ti, Si and the like are added to the molten metal. Because Cr and Ti are liable to be oxidized particularly, it is preferable to be added lastly. It is preferable to take the data of the loss of Cr and Ti during casting beforehand, and to make the molten metal contain Cr and Ti that make up the amount of the loss.
(7) After sampling the molten metal and confirming that the composition is within the target range, casting is started. When casting is executed by introducing the molten metal from the furnace to the casting mold through a trough, casting is executed while covering the surface of the molten metal that flows through the trough with the charcoal, graphite grains and the like in order to prevent oxidation in the trough, and sealing the molten metal with Ar gas or nitrogen gas. Further, a countermeasure of providing a cover on the upper face of the trough to arrange a sealed structure, or shortening the length of the trough is also effective.
(8) In order that the slag such as oxides, sulfides, carbides and the like having floated to the molten metal surface inside the furnace is not taking in to the ingot, casting is executed preferentially from the molten metal of the bottom inside the furnace. For example, a partition plate and the like is arranged inside the furnace and in the trough to make the molten metal in the upper part of the furnace hardly flow out.
(9) The temperature of the molten metal in casting is preferable to be approximately 1,120-1,250° C. at the position immediately before being poured to the casting mold.

### (Working Heat Treatment Step)

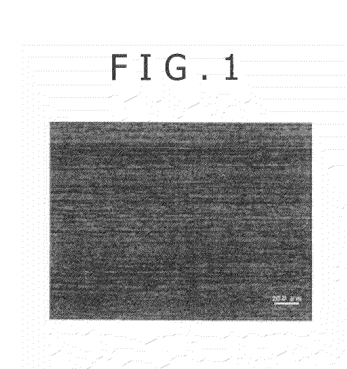

Thereafter, the ingot is subjected to soaking treatment for 0.5 hour or more at 800-1,000° C., is thereafter subjected to hot rolling with the working ratio of 60% or more, and is quenched from the temperature of 700° C. or above. Then, cold rolling and heat treatment are repeated to be finished to a copper alloy sheet (or strip) having a desired thickness. The heat treatment aims an aging precipitation treatment for forming Cr, or compounds of Cr—Si, Cr—Si—Ti, and the like, and is executed in a condition of 0.5 hour or more at 400-550° C. With respect to the temperature of this heat treatment, it is preferable to select a condition of 400-475° C. and recrystallization does not take place perfectly (a condition a fiber structure obtained by cold rolling remains) when it is desired to increase the strength after the heat treatment, and to select a range exceeding 475° C. and below 550° C. when it is desired to improve the electric conductivity. Also, when it is desired to increase the strength, it is appropriate to select a temperature at which the yield stress after the heat treatment becomes as high as possible and the elongation becomes 10% or more. The photo of the microscopic structure of the surface of the copper alloy sheet after the heat treatment (No. 4 of the example) is shown in FIG. 1. As shown in FIG. 1, instead of a recrystallized structure, a working structure of a fiber shape extending in the rolling direction is observed.

Before the first heat treatment (aging precipitation treatment), a solution heat treatment accompanying recrystallization may be executed by heating the copper alloy plate for a short time to a temperature of 700° C. or above. When this solution heat treatment is to be executed, the steps until starting the first heat treatment can be exemplified as; hot rolling→solution heat treatment→cold rolling→heat treatment, or hot rolling→cold rolling→solution heat treatment→cold rolling→heat treatment.

Although the working and heat treatment step may be finished at the heat treatment (aging precipitation treatment), it is also possible to execute cold rolling after the heat treatment (aging precipitation treatment), or to execute cold rolling after the heat treatment (aging precipitation treatment) and to further execute low temperature annealing in a condition recrystallization does not occur.

Also, the working heat treatment step and the conditions therefor described above remain unchanged from those of prior arts.

### Example 1

Below, the advantageous effects of an aspect of the present invention will be described comparing examples satisfying the requirement of an aspect of the present invention with comparative examples not satisfying the requirement of an aspect of the present invention.

Electrolytic copper metal, scraps obtained after punching oxygen free copper attached with lubricating oil, wire cable scraps, and alloy element metal/intermediate alloy were blended, copper alloys having various alloy compositions shown in Tables 1, 2 (Nos. 1-30) were smelted, were cast into a book mold, and ingots with 70 mm thickness were obtained. In smelting the copper alloy, according to the procedure of the melting and casting step described in [manufacturing method] of the detailed description of the invention, S, C, and O contents of the copper alloy were reduced. However, with respect to some copper alloys, after reducing the S, C, and O contents, following operations were applied successively, and the S, C, and O contents were adjusted (increased). S content was adjusted by blending Cu-1.2 mass % S alloy and Cu-0.4 mass % S alloy which had been prepared beforehand. C content was adjusted by scattering graphite powder of fine mesh onto the surface of the molten metal. O content was adjusted by scattering cuprous oxide (Cu2O) powder onto the surface of the molten metal.

TABLE 1

| | | | | | | | | | | | | Properties | | |
|---|---|---|---|---|---|---|---|---|---|---|---|---|---|---|
| | | | | | | | | | | | | | | Stress |
| | Chemical composition (mass %) | | | | | | | | | | | Electric | Proof | relaxa- |
| | | | | | | | | | | Sn + Mg + | | conductivity | stress | tion |
| No. | Cr | Ti | Si | S | O | C | S + O + C | H | Sn, Mg, Zn | Zn | Cu | % IACS | N/mm² | ratio % |
| 1 | 0.380 | 0.007 | 0.020 | 0.0010 | 0.0012 | 0.0010 | 0.0032 | 0.0001 | — | — | Balance | 85 | 562 | 19 |
| 2 | 0.370 | 0.140 | 0.020 | 0.0015 | 0.0011 | 0.0030 | 0.0056 | 0.0001 | — | — | Balance | 67 | 580 | 20 |
| 3 | 0.270 | 0.062 | 0.015 | 0.0011 | 0.0015 | 0.0011 | 0.0037 | 0.0001 | — | — | Balance | 78 | 551 | 11 |
| 4 | 0.270 | 0.080 | 0.020 | 0.0013 | 0.0014 | 0.0011 | 0.0038 | 0.0001 | — | — | Balance | 78 | 542 | 10 |
| 5 | 0.280 | 0.075 | 0.025 | 0.0005 | 0.0008 | 0.0011 | 0.0024 | 0.0001 | Sn: 0.15 | 0.835 | Balance | 55 | 585 | 8 |
| | | | | | | | | | Mg: 0.025 | | | | | |
| | | | | | | | | | Zn: 0.66 | | | | | |
| 6 | 0.382 | 0.150 | 0.019 | 0.0014 | 0.0009 | 0.0020 | 0.0043 | 0.0002 | Sn: 0.032 | 0.072 | Balance | 61 | 627 | 11 |
| | | | | | | | | | Mg: 0.027 | | | | | |
| | | | | | | | | | Zn: 0.013 | | | | | |
| 7 | 0.160 | 0.009 | 0.019 | 0.0015 | 0.0010 | 0.0010 | 0.0035 | 0.0001 | — | — | Balance | 87 | 460 | 18 |
| 8 | 0.170 | 0.140 | 0.021 | 0.0011 | 0.0014 | 0.0010 | 0.0035 | 0.0001 | — | — | Balance | 68 | 465 | 14 |
| 9 | 0.250 | 0.055 | 0.010 | 0.0010 | 0.0014 | 0.0010 | 0.0034 | 0.0001 | — | — | Balance | 82 | 543 | 10 |
| 10 | 0.250 | 0.050 | 0.030 | 0.0015 | 0.0010 | 0.0012 | 0.0037 | 0.0001 | — | — | Balance | 79 | 562 | 19 |
| 11 | 0.270 | 0.056 | 0.021 | 0.0045 | 0.0009 | 0.0009 | 0.0063 | 0.0001 | — | — | Balance | 81 | 521 | 17 |
| 12 | 0.270 | 0.056 | 0.021 | 0.0040 | 0.0020 | 0.0010 | 0.0070 | 0.0002 | — | — | Balance | 75 | 505 | 20 |
| 13 | 0.380 | 0.130 | 0.018 | 0.0014 | 0.0011 | 0.0011 | 0.0036 | 0.0001 | Sn: 0.01 | 0.045 | Balance | 65 | 620 | 13 |
| | | | | | | | | | Mg: 0.005 | | | | | |
| | | | | | | | | | Zn: 0.03 | | | | | |
| 14 | 0.150 | 0.008 | 0.021 | 0.0015 | 0.0010 | 0.0010 | 0.0035 | 0.0001 | Sn: 0.015 | 0.035 | Balance | 82 | 492 | 15 |
| | | | | | | | | | Mg: 0.015 | | | | | |
| | | | | | | | | | Zn: 0.005 | | | | | |
| 15 | 0.370 | 0.120 | 0.020 | 0.0013 | 0.0011 | 0.0010 | 0.0034 | 0.0001 | Sn: 0.014 | 0.024 | Balance | 68 | 623 | 13 |
| | | | | | | | | | Mg: 0.01 | | | | | |

TABLE 2

| | | | | | | | | | | | | Properties | | |
|---|---|---|---|---|---|---|---|---|---|---|---|---|---|---|
| | | | | | | | | | | | | | | Stress |
| | Chemical composition (mass %) | | | | | | | | | | | Electric | Proof | relaxa- |
| | | | | | | | | | | Sn + Mg + | | conductivity | stress | tion |
| No. | Cr | Ti | Si | S | O | C | S + O + C | H | Sn, Mg, Zn | Zn | Cu | % IACS | N/mm² | ratio % |
| 16 | 0.420 | 0.015 | 0.023 | 0.0010 | 0.0008 | 0.0010 | 0.0028 | 0.0001 | — | — | Balance | 83 | 565 | 23 |
| 17 | 0.410 | 0.145 | 0.021 | 0.0009 | 0.0009 | 0.0010 | 0.0028 | 0.0001 | — | — | Balance | 68 | 585 | 21 |
| 18 | 0.330 | 0.002 | 0.017 | 0.0010 | 0.0010 | 0.0010 | 0.0030 | 0.0001 | — | — | Balance | 85 | 501 | 22 |
| 19 | 0.340 | 0.180 | 0.015 | 0.0008 | 0.0009 | 0.0010 | 0.0027 | 0.0001 | — | — | Balance | 63 | 583 | 17 |
| 20 | 0.160 | 0.002 | 0.021 | 0.0010 | 0.0009 | 0.0010 | 0.0029 | 0.0001 | — | | Balance | 87 | 454 | 22 |
| 21 | 0.170 | 0.175 | 0.021 | 0.0005 | 0.0014 | 0.0010 | 0.0029 | 0.0001 | — | | Balance | 64 | 460 | 15 |
| 22 | 0.130 | 0.013 | 0.023 | 0.0013 | 0.0010 | 0.0010 | 0.0033 | 0.0001 | — | — | Balance | 83 | 450 | 24 |
| 23 | 0.140 | 0.130 | 0.020 | 0.0011 | 0.0012 | 0.0010 | 0.0033 | 0.0001 | — | — | Balance | 72 | 458 | 22 |
| 24 | 0.270 | 0.052 | 0.055 | 0.0021 | 0.0009 | 0.0010 | 0.0040 | 0.0001 | — | — | Balance | 64 | 553 | 23 |
| 25 | 0.250 | 0.058 | 0.024 | 0.0070 | 0.0010 | 0.0010 | 0.0090 | 0.0001 | — | — | Balance | 73 | 538 | 22 |
| 26 | 0.382 | 0.150 | 0.019 | 0.0014 | 0.0009 | 0.0020 | 0.0043 | 0.0001 | Sn: 0.6 | 1.912 | Balance | 51 | 641 | 11 |
| | | | | | | | | | Mg: 0.052 | | | | | |
| | | | | | | | | | Zn: 1.26 | | | | | |
| 27 | 0.238 | 0.049 | 0.021 | 0.0100 | 0.0020 | 0.0015 | 0.0135 | 0.0001 | — | — | Balance | 68 | 531 | 28 |
| 28 | 0.230 | 0.052 | 0.021 | 0.0040 | 0.0120 | 0.0015 | 0.0175 | 0.0002 | — | | Balance | 68 | 521 | 31 |
| 29 | 0.234 | 0.055 | 0.021 | 0.0040 | 0.0020 | 0.0080 | 0.0140 | 0.0001 | — | | Balance | 68 | 525 | 29 |
| 30 | 0.240 | 0.050 | 0.021 | 0.0040 | 0.0020 | 0.0015 | 0.0075 | 0.0001 | — | | Balance | 68 | 530 | 24 |

After this ingot was subjected to soaking treatment for 1 hour at 950° C., the plate thickness was made 18 mm by hot rolling, and quenching was executed from a temperature of 700° C. or above. Next, both surfaces of the copper alloy plate after quenching were polished by the thickness of approximately 1 mm, and oxidized scale on the surface was removed. Thereafter, the copper alloy plate was formed into 0.64 mm thickness by cold rolling. Then, from each copper alloy sheet (cold rolled material), a plurality of sheets were cut respectively, and heat treatment (aging precipitation treatment) of 2 hours each was executed at a heat treatment temperature different for each (the temperature of every 20° C. within the range of 400-500° C.) with respect to each sheet. Thus, with respect to the copper alloys of Nos. 1-30, a plurality of copper alloy sheets (heat treated material) subjected to heat treatment (aging precipitation treatment) at a temperature different for each were obtained.

Also, all of the contents of the elements not described in Tables 1, 2 (inevitable impurities) were the detection limit or less. Even if Al, Fe, Ni, As, Sb, B, Pb, V, Zr, Mo, Mn, Hf, Ta, Bi, Ag, In, and Co cited above might be included, the total content thereof is extremely minute amount.

The plurality of copper alloy sheets (heat treated material) obtained for each copper alloy of Nos. 1-30 were made test samples, and the mechanical property (0.2% proof stress) was measured by a testing method described below.

### (Measurement of Mechanical Property)

From each test sample, JIS No. 5 specimen stipulated in JIS Z 2241 was manufactured so that the rolling direction became the longitudinal direction. Using this specimen, the tensile test stipulated in JIS Z 2241 was executed, and the elongation and 0.2% proof stress (the tensile strength equivalent to 0.2% of the permanent elongation) were measured. With respect to each copper alloy of Nos. 1-30, specimens whose elongation exceeded 10% were selected, and one specimen having the largest proof stress among them was selected. The proof stress values of the specimens selected are shown in Tables 1, 2. Those having 460 N/mm² or more of 0.2% proof stress were evaluated to have passed.

With respect to each copper alloy of Nos. 1-30, using the test samples selected in the measuring test of the mechanical property, the electric conductivity and the stress relaxation ratio were measured by the procedure described below, and S, C, and O contents were analyzed. The results are shown in Tables 1 and 2.

### (Measurement of Electric Conductivity)

Measurement of the electric conductivity was executed by measuring the volume resistivity by a four terminal method using double bridges according to the Measuring Methods for Electric Conductivity of Non-Ferrous Materials stipulated in JIS H 0505. Also, the electric conductivity was obtained by dividing the measured volume resistivity by the volume resistivity of the International Annealed Copper Standard 1.7241×10⁻⁸ Ω·m and expressing the product by percent. With respect to the copper alloys of Nos. 5, 6, 13-15, and 26 containing one element or two elements or more selected from the group consisting of Sn, Mg, and Zn, those in which the electric conductivity was 55% IACS or more were evaluated to have passed, and, with respect to others, those in which the electric conductivity was 65% IACS or more were evaluated to have passed.

### (Measurement of Stress Relaxation Ratio)

From each test sample, a strip specimen with 10 mm width and 90 mm length was manufactured so that the rolling direction became the longitudinal direction. Using this specimen, the stress relaxation ratio was measured according to the cantilever method of the Japan Copper and Brass Association Technical Standards “Standard method for stress relaxation test by bending for copper and copper alloy thin sheets and strips” (JCBA-T309: 2004). First, one end of the specimen was fixed to a rigid test stand, deflection of 10 mm was imparted to the specimen at the position of a constant distance (span length) from the fixed end, and a surface stress equivalent to 80% of the 0.2% proof stress of the testing material was applied to the fixed end. The span length was determined based on the expression shown in the Technical Standards. Also, this measuring method is same to that described in JP-A 2012-214882.

The specimen fixed to the rigid test stand thus was held for a predetermined time inside an oven heated to a constant temperature and was thereafter taken out, the permanent strain 8 of the time the deflection amount d (=10 mm) was removed was measured, and the stress relaxation ratio RS was measured by the expression described below. With respect to the heating condition, although a condition of being held for 1,000 hours at 150° C. has been stipulated for example in JASO of the Society of Automotive Engineers of Japan, matching sophistication of the demand for the stress relaxation resistance characteristic of the terminal material for an automobile, the stress relaxation ratio was measured in a severer condition of being held for 1,000 hours at 160° C. Those having the stress relaxation ratio of 20% or less were evaluated to have passed.

Stress relaxation ratio RS=(δ/d)×100

(Analysis of S, C, and O contents)

For analysis of S, the Carbon/Sulfur Analyzer EMIA-610 made by Horiba, Ltd. was used. Measurement was in accordance with JIS H 1070, and was executed by the combustion-infrared absorption method (integration method). In this apparatus, 1.0 g of a sample to be measured is placed on a ceramics boat, and is burnt at 1,350° C. within an O stream. At this time, S in the sample is converted to sulfur dioxide (SO₂), is transported by the O stream, and is analyzed by a non-dispersion infrared detector.

The same apparatus was used also for analysis of C. Measurement was in accordance with JIS G 1211-3, and was executed by the combustion-infrared absorption method (integration method). The combustion temperature is 1,200° C. in the case of C, and C in the sample is converted to carbon dioxide (CO2) and carbon monoxide (CO).

For analysis of O, EMGA-650A made by Horiba, Ltd. was used. Measurement was in accordance with JIS H 1067, and was executed by the inert gas fusion infrared absorption method. In this apparatus, the sample of 0.5 g is put in a degassed carbon crucible, and the sample is fused at approximately 3,000° C. by Joule's heat. At this time, O generated from the sample combines with C of the carbon crucible, is converted to CO, and is analyzed by the non-dispersion infrared detector. In analyzing H, RH-402 made by LECO Corporation was used. The sample of 1.0 g is fused in an N atmosphere, H generated from the sample then is transferred to the thermal conductivity detector along with N, and H content is measured from the difference in the thermal conductivity with respect to N.

In example Nos. 1-15 satisfying the requirement of an aspect of the present invention, the stress relaxation ratio is 20% or less and the stress relaxation resistance characteristic is excellent, and the electric conductivity and the 0.2% proof stress are high.

On the other hand, In Nos. 16 and 17, Cr content is excessive, and the stress relaxation ratio exceeds 20% in the both. In Nos. 22 and 23, Cr content is insufficient, and the 0.2% proof stress is low and the stress relaxation ratio exceeds 20% in the both.

In Nos. 18 and 20, Ti content is low, the stress relaxation ratio exceeds 20% in the both, and the 0.2% proof stress is low in No. 20. In Nos. 19 and 21, Ti content is excessive, and the electric conductivity is low in the both.

In No. 24, Si content is excessive, the electric conductivity is low, and the stress relaxation ratio exceeds 20%.

In No. 26, the total content of Sn, Mg, and Zn is excessive, and the electric conductivity is low.

In Nos. 25 and 27-30, any of S, O, and C contents is excessive or the total content of S, O, and C is excessive, and the stress relaxation ratio exceeds 20%.

### Example 2

Electrolytic copper metal, scraps obtained after punching the terminals attached with lubricating oil, wire cable scraps, and alloy element metal/intermediate alloy were blended, and two ingots with 220 mm thickness, 550 mm width, and 5,000 mm length were manufactured. With respect to one ingot, the molten metal was treated according to the procedure described in [manufacturing method] of the detailed description of the invention. With respect to the other ingot, only a general treatment method of the molten metal according to a prior art was followed, and the treatment of largely reducing S, C, and O contents was not executed.

TABLE 3

| | | | | | | | | | | | | Properties | | |
|---|---|---|---|---|---|---|---|---|---|---|---|---|---|---|
| | | | | | | | | | | | | | | Stress |
| | Chemical composition (mass %) | | | | | | | | | | | Electric | Proof | relaxa- |
| | | | | | | | | | | Sn + Mg + | | conductivity | stress | tion |
| No. | Cr | Ti | Si | S | O | C | S + O + C | H | Sn, Mg, Zn | Zn | Cu | % IACS | N/mm² | ratio % |
| 31 | 0.320 | 0.050 | 0.040 | 0.0013 | 0.0012 | 0.0009 | 0.0034 | 0.0001 | Sn: 0.03 | 0.30 | Balance | 72 | 563 | 12 |
| | | | | | | | | | Mg: 0.02 | | | | | |
| | | | | | | | | | Zn: 0.25 | | | | | |
| 32 | 0.313 | 0.048 | 0.039 | 0.0065 | 0.0025 | 0.0037 | 0.0127 | 0.0001 | Sn: 0.04 | 0.33 | Balance | 68 | 540 | 26 |
| | | | | | | | | | Mg: 0.02 | | | | | |
| | | | | | | | | | Zn: 0.27 | | | | | |

The copper alloy ingots manufactured thus (Nos. 31 and 32) were subjected to soaking treatment for 2 hours at 950° C., the plate thickness was thereafter made 20 mm by hot rolling, and quenching was executed from a temperature of 700° C. or above over the entire length. Next, both surfaces of the copper alloy plate after quenching were subjected to facing by the thickness of approximately 1 mm each, and oxidized scale on the surface was removed. Thereafter, the copper alloy plate was formed into 0.60 mm thickness by cold rolling. Then, from each copper alloy sheet (cold rolled material), a plurality of sheets were cut respectively, and heat treatment (aging precipitation treatment) of 3 hours each was executed at a heat treatment temperature different for each (the temperature of every 20° C. within the range of 400° C.-480° C.) with respect to each sheet. Thus, with respect to the copper alloys of Nos. 31 and 32 shown in Table 3, a plurality of copper alloy plates (heat treated material) subjected to heat treatment (aging precipitation treatment) at a temperature different for each were obtained. Also, all of the contents of the elements not described in Table 3 (inevitable impurities) were the detection limit or less, and, even if Al, Fe, Ni, As, Sb, B, Pb, V, Zr, Mo, Mn, Hf, Ta, Bi, Ag, In, and Co might be included, the total content thereof is of an extremely minute amount.

The plurality of copper alloy sheets (heat treated material) obtained for each copper alloy of Nos. 31 and 32 were made test samples, and the mechanical property (0.2% proof stress) was measured. With respect to each copper alloy of Nos. 31 and 32, similarly to example 1, specimens whose elongation exceeded 10% were selected, and one specimen having the largest proof stress among them was selected. Using the test sample selected, the electric conductivity and the stress relaxation ratio were measured, and S, C, and O contents were analyzed. The results are shown in Table 3. In example No. 31 satisfying the requirement of an aspect of the present invention, the stress relaxation ratio is 20% or less and the stress relaxation resistance characteristic is excellent, and the electric conductivity and the 0.2% proof stress are high. On the other hand, in No. 32, although the content of each alloy element is generally same to that of No. 31, the content of S and the total content of S, O, and C are excessive, the 0.2% proof stress is inferior compared to No. 31, and the stress relaxation ratio exceeds 20%. Its reason is considered to be that sulfides, oxides, carbides and the like of Cr, Ti, and Si have been formed much.

1. A copper alloy comprising:
Cu;
Cr in 0.15-0.4 mass %;
Ti in 0.005-0.15 mass %; and
Si in 0.01-0.05 mass %,
wherein any S, O, and C present is restricted to S: 0.005 mass % or less, O: 0.005 mass % or less, and C: 0.004 mass % or less, and the total of S, O, and C is restricted to 0.007 mass % or less.

2. The copper alloy according to claim 1, further comprising at least one element selected from the group consisting of Zn, Sn, and Mg, wherein a total amount of Zn, Sn, and Mg in the copper alloy is 0.001-1.0 mass %.
